(19) United States
(12) Patent Application Publication
(10) Pub. No.: US 2008/0040350 A1
(43) Pub. Date: Feb. 14, 2008

(54) Image Log Record Management System, Image Processor, Image Log Record Management Device, And Computer-Readable Medium

(75) Inventor: Hironobu Aoki, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/684,678

(22) Filed: Mar. 12, 2007

(30) Foreign Application Priority Data
Aug. 10, 2006 (JP) 2006218287

(51) Int. Cl. G06F 17/30; G06F 15/00

(52) U.S. Cl. 707/9; 358/1.15; 707/104.1; 707/E17.031

(57) ABSTRACT

There is provided an image processor having a processing unit that executes an image output process; a first registration unit that registers recording image data corresponding to an output image of the image output process in a predetermined retaining device which can be accessed from an image log record management device which manages log record data of an image output process; a viewing image generator that generates viewing image data based on the output image, the viewing image data having a reduced amount of data as compared with the recording image data; and a second registration unit that registers, to the image log record management device, log record data including the viewing image data and access information for enabling access to the recording image data registered in the retaining device.

### CROSS-REFERENCE TO RELATED APPLICATIONS

This application is based on and claims priority under 35 USC 119 from Japanese Patent Application No. 2006-218287, filed on Aug. 10, 2006.

### BACKGROUND

1. Technical Field

The present invention relates to an image processor and an image processing system, and, more particularly, to recording of an image output by an image processor.

2. Related Art

In recent years, image processors, such as printers, scanners, digital copiers, and digital multifunction devices, connected to a network such as LAN (Local Area Network) have been used via the network more and more frequently. In addition, in recent years, as a countermeasure to leakage of confidential information in a company or the like, there has been proposed a system in which an image output by an image processor in the form of, for example, printing, scanning, copying, or facsimile transmission, is recorded as log record data along with, for example, the output date and time and outputting user, to thereby enable tracing of what image has been output by whom and when, by means of checking the log record. In an environment in which many image processors are connected to a network, in order to collectively manage the log records at image processors, the log record data generated by the image processors are collected and recorded on a log record management device provided on the network.

### SUMMARY

According to one aspect of the present invention, there is provided an image log record management system having multiple image processors and an image log record management device. The image processor has a processing unit that executes an image output process; a first registration unit that registers recording image data corresponding to an output image of the image output process in a retaining device which can be read from the image log record management device; a viewing image generator that generates viewing image data based on the output image, the viewing image data having a reduced amount of data as compared with the recording image data; and a second registration unit that registers, to the image log record management device, log record data including the viewing image data and access information for enabling access to the recording image data registered in the retaining device. The image log record management device has a storage unit that stores log record data registered from the image processor, a first presentation processor that executes a process for presenting viewing image data included in log record data stored in the storage unit, and a second presentation processor that executes a process for acquiring recording image data from the retaining device using access information included in selected log record data and for presenting the recording image data.

### BRIEF DESCRIPTION OF THE DRAWINGS

Exemplary embodiment(s) of the present invention will be described in detail by reference to the following figures, wherein:

FIG. 1 is a diagram for explaining an example system to which log record management of an exemplary embodiment of the present invention is applied;

FIG. 2 is a diagram showing an example detailed structure for managing log according to an exemplary embodiment of the present invention;

FIG. 3 is a diagram exemplifying data content of a log record;

FIG. 4 is a diagram showing another example structure for log management;

FIG. 5 is a diagram showing an example structure for handling a situation with an operation such as deletion or change with respect to recording image data stored in a client device;

FIG. 6 is a diagram for explaining an example system to which a log management according to another exemplary embodiment of the present invention is applied;

FIG. 7 is a diagram showing an example detailed structure of log management in a system of FIG. 6; and

FIG. 8 is a diagram exemplifying a hardware structure of a computer.

### DETAILED DESCRIPTION

An exemplary embodiment of the present invention will now be described by reference to the drawings. In the drawings, identical or similar elements are assigned the same reference numerals.

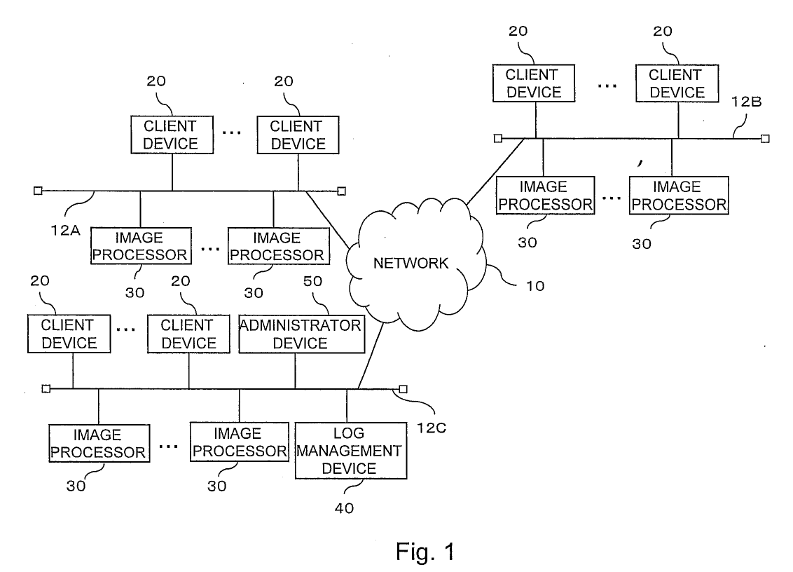

First, by reference to FIG. 1, there will be described an example environment to which the log record management of the exemplary embodiment is applied. The environment shown in FIG. 1 includes multiple sub-networks 12A, 12B, 12C, . . . which are interconnected via a network 10. Each of the sub-networks 12A-12C may be a local area network (LAN) or a wide area network (WAN). Similarly, the network 10 may be a LAN or a WAN. One or more client devices 20 and one or more image processors 30 are connected to each of the sub-networks 12 A-12C.

The image processor 30 is a device which provides an image output process service to a user. Thus, the image processor 30 may be, for example, a digital multifunction device, a printer, a scanner, a facsimile device, or a server equipped with an application for image process services. In the image output process service, an image is output in some form. An output of an image at an image output process service of the image processor 30 may be in the form of physical formation of an image on paper or the like or in the form of storage and transmission as electronic image data.

The image processor 30 provides the image output process service for the client device 20 via one or both of the network 10 and the sub-networks 12A-12C. The image output process service provided by the image processor 30 can be roughly divided into a category of services for a remote user who operates the client device 20 to instruct the image processor 30 and a category of services for a local user who instructs a process through an operation panel of the image processor 30.

The services for a remote user include, for example, printing, facsimile transmission, distribution of images using various protocols, and transmission of the processed image to the client device 20. The printing service is a service for printing print data transmitted from the client device 20 (the print data may be data described in a page description language or may be image data which can be printed without further processing). Facsimile transmission is a service for transmitting to a designated destination via facsimile an image transmitted from the client device 20. The distribution of images using a protocol include, for example, transmission to an instructed destination through an electronic mail; storage in an instructed file server, database, or private box (storage region allocated for each user in a storage device of a device such as a digital copier) using a network file system, a file transfer protocol, a database protocol, etc.; and submission to an instructed electronic bulletin board through a protocol such as HTTP (Hypertext Transfer Protocol). In addition, another example of a service provided by the image processor 30 to the client device 20 is a process for generating, according to instruction data transmitted from the client device 20, an image by processing within the image processor 30 or instructing one or more other servers on the network, and for printing, transmitting through facsimile, or distributing the image by the image processor 30. When the image processor 30 has a scanner, a service for reading a document in response to a scanning instruction from a client device 20 and for transmitting the read image to the client device 20 is also an example of the services for a remote user.

The services for the local user are services provided by the image processor 30 in response to an operation by a user with respect to a user interface (hereinafter referred to as “UI”) such as an operation panel provided on the image processor 30. This kind of services include, for example, services in which a scanner provided on the image processor 30 (or a scanner connected to the image processor 30) reads a document, and a read image (or an image obtained by subjecting the read image to a process at a server on the network) is printed, transmitted through facsimile, or distributed by means of any of various protocols. In addition, the services for the user locally operating the image processor 30 also include services in which an execution instruction of a service provided by the image processor 30 or one or more servers on the network (or a service provided through cooperation between the image processor 30 and/or the one or more servers) is input through the UI of the image processor 30, and the image obtained by the execution of the service is printed, transmitted through facsimile, or distributed by means of any of various protocols.

The image output process services described above are only examples. The image processor 30 may provide an image output process service different from those described above to the remote user or to the local user. In addition, the image processor 30 does not necessarily provide all of the exemplified services.

The client device 20 is a device which requests a process to the image processor 30, and typically is a computer such as a personal computer or a workstation. The client device 20 has a unit which executes a process necessary for requesting a process to the image processor 30. This unit may be, for example, realized by a processor in the image processor 30 executing a program. As such a program, for example, there exist programs commonly referred to as peripheral device drivers, such as printer drivers and scanner drivers. When the client device 20 has a peripheral device driver corresponding to the image processor 30, the client device 20 can request a process to the image processor 30.

On the network 10 or the sub-networks 12A-12C, one or more log management devices 40 and one or more administrator devices 50 are connected. The log management device 40 is a device which stores a log record indicating a record of a process executed by the image processor 30. The log record stored by the log management device 40 includes information items such as, for example, the date and time when the process is executed, and identification information of the image processor 30 executing the process. Log records of processes executed by the image processors 30 within the present system are collected and stored in the log management device 40.

In the related art, as this type of log management device, there exists a device in which image data output by the image processor 30 during the process is stored as an item of the log record. Image quality of a certain level or greater is required for the image data to be stored in the log. The required image quality is determined in view of various factors such as, for example, the degree of precision of analysis required for the output image. In this manner, the log management device of the related art stores the image data of an image quality required for the object of the log management device.

In contrast, the log management device 40 of the exemplary embodiment does not store the image data having the image quality required for the object such as monitoring and analysis at the log management device 40 (hereinafter referred to as “recording image data”), and instead stores, as an item of log record data, simple image data for viewing (hereinafter referred to as “viewing image data”) having a reduced amount of data as compared with the recording image data. The recording image data are stored in another device which can be accessed from the log management device 40, such as a client device 20.

The administrator device 50 is a computer operated by an administrator who monitors or analyzes the image output process at each image processor 30. The administrator accesses the log management device 40 through operation of the administrator device 50 and views the log record. Here, the administrator views the viewing image data corresponding to individual image output process provided from the log management device 40, and, when a more detailed investigation is required, the administrator requests the log management device 40 to provide recording image data corresponding to the viewing image data. In response to the request, the log management device 40 acquires the recording image data from the device storing the recording image data and provides the recording image data to the administrator device 50.

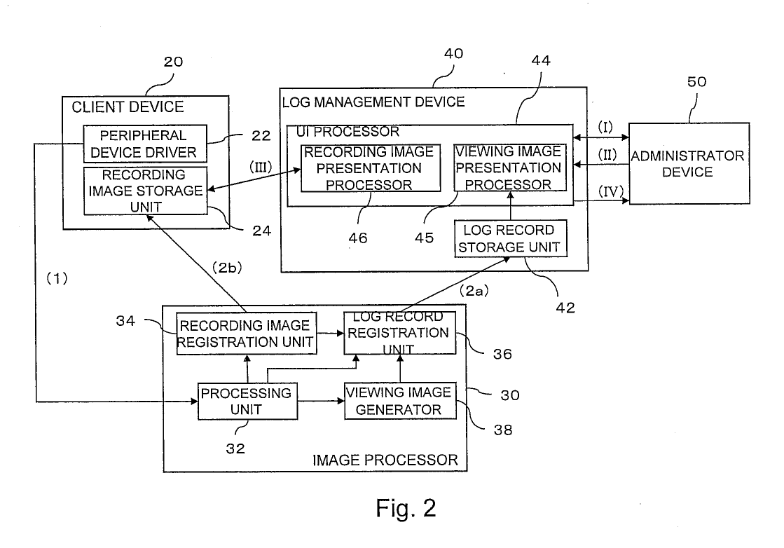

Next, an example detailed structure for log management in the exemplary embodiment will be described by reference to FIG. 2. This example is an example of a case in which the recording image data representing the output image of the image process output image are stored in the client device 20 requesting the image output process to the image processor 30. Exchange of data among the client device 20, the image processor 30, the log management device 40, and the administrator device 50 is executed via one or more of the network 10 and the sub-networks 12A-12C.

In the example configuration shown in FIG. 2, the client device 20 has a peripheral device driver 22 corresponding to the image processor 30, and a recording image storage unit 24. The peripheral device driver 22 is software for operating the image processor 30. The recording image storage unit 24 is a memory region for storing a recording image corresponding to an image output from the image processor 30. The recording image storage unit 24 may be realized, for example, as a shared folder managed by an operating system (OS) of the client device 20. In this case, access rights are set such that each image processor 30 can write a file for the recording image data in the shared folder and the log management device 40 can read files from the shared folder. Alternatively, in place of the recording image storage unit 24 being realized as a shared folder, the recording image storage unit 24 may be realized, for example, as a database in which a registration authority of data is assigned for each image processor 30 and reading authority of registered data is assigned for the log management device 40.

When the user operates an application program on the client device 20 to instruct a process to the image processor 30, the peripheral device driver 22 generates instruction data which can be handled by the image processor 30 and transmits the instruction data to the image processor 30 (dataflow (1) in FIG. 2). For example, when the instruction is a print instruction, the peripheral device driver 22 generates print data which indicate a document image to be printed in a page description language (PDL) and transmits the print data to the image processor 30 along with print parameter information such as a number of copies and data indicating single-sided printing or double-sided printing. When the instruction is a scan instruction, for example, the peripheral device driver 22 generates scan instruction data including a scan parameter such as resolution, and transmits the scan instruction data to the image processor 30.

In response to the instruction data from the client device 20, a processing unit 32 of the image processor 30 executes the above-described image output process service provided by the image processor 30. The processing unit 32 has a hardware component and software for executing the service. In addition, the processing unit 32 may include a function for executing a service in cooperation with a server on any of the network 10 and the sub-networks 12A-12C. The processing unit 32 outputs an image as a result of the requested image output process service. The output of the image may be, for example, in a form of printing on paper. The output of the image may alternatively be in the form of, for example, storage of the read image or processed image in the image processor 30 as electronic data or transmission of the read image or the processed image to the requesting client device 20 or an instructed destination. Alternatively, the processing unit 32 may have functions for providing, to the client device 20, a list of image output services which can be provided by the image processor and executing a service selected by the user from the list through operation of the client device 20.

A recording image registration unit 34 of the image processor 30 registers, to the recording image storage unit 24 of the client device 20 requesting the service, the recording image data corresponding to the output image which is output by the processing unit 32 as a result of the image output process service (dataflow (2b)). The recording image data may be the output image data themselves which are used in the image output process or may be image data obtained by subjecting the output image data to a process. The recording image registration unit 34 generates access information for enabling access, via the network, to the recording image data registered in the recording image storage unit 24, and sends the access information to a log record registration unit 36. The access information is, for example, information indicating an address of the recording image data registered in the recording image storage unit 24 on the network (for example, a URL (Uniform Resource Locator). In this case, the address information may be generated on the basis of identification information of the client device 20 on the network (for example, a host name and IP address), a path name of the recording image storage unit 24 in the client device 20, and a file name of the recording image data. The identification information of the client device 20 on the network may be, for example, notified from the client device 20 to the image processor 30 in accordance with a protocol during transmission of instruction data or may be included in the instruction data. The path name of the recording image storage unit 24 may be provided in a similar manner. By setting the path of the recording image storage unit 24 to be common in all client devices 20 and registering the common path name in the image processor 30, it is possible to eliminate the need to inform the path name from the client device 20 to the image processor 30.

The file name of the recording image data registered in the recording image storage unit 24 must be unique, at least within the recording image storage unit 24. Such a unique file name may be assigned by the recording image storage unit 24 or by the recording image registration unit 34. In the former case, the recording image storage unit 24 notifies the recording image registration unit 34 of the assigned file name, and the recording image registration unit 34 generates the above-described address information on the basis of the file name and provides the address information to the log record registration unit 36. In the latter case, the recording image registration unit 34 can prevent assignment of the same file name by different image processors 30 by incorporating, for example, information unique to the image processor 30 (for example, a host name or other identification information) in the file name of the recording image data. An example configuration has been described in which the recording image storage unit 24 manages each set of recording image data as a file. In a configuration in which the recording image data are managed by a database other than a file system also, the identification information of the recording image data to be registered in the database must be uniquely assigned by the recording image storage unit 24 or the recording image registration unit 34 in a similar manner. In this case, it is possible to use, as the access information corresponding to the recording image data, a combination of the identification information of the recording image storage unit 24 on the network and identification information of the recording image data within the recording image storage unit 24.

The access information to the recording image data is not limited to an address of the data on the network. The access information may be any unique information, so long as a server which resolves the address of the recording image data from the access information is provided on the network.

The log record registration unit 36 generates a log record with respect to a process executed by the processing unit 32 and registers the log record in the log management device 40 (dataflow (2a)). A log record corresponding to a certain process includes items such as the date and time of the process and identification information of the image processor 30, and, in addition, the viewing image data corresponding to the output image of the process and access information for the recording image data registered in the client device 20.

The viewing image data are image data which are used by the administrator for quickly checking the image output in each process, and have a reduced amount of data as compared with the recording image data. The viewing image data are generated by a viewing image generator 38. More specifically, the viewing image generator 38 applies, to the output image of the processing unit 32, an image process for reducing the amount of data, such as subsampling of pixels or an image compression based on a compression algorithm such as JPEG, to thereby generate the viewing image data.

The log record registration unit 36 generates a log record including the viewing image data generated by the viewing image generator 38 and access information for enabling access to the recording image data, and transmits the generated log record to the log management device 40.

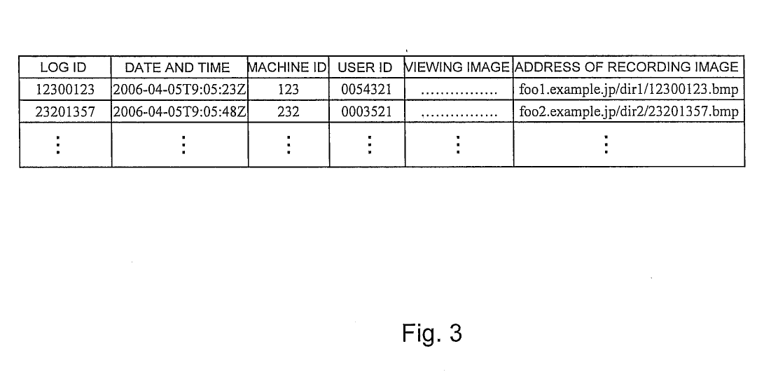

At the log management device 40, the log record transmitted from the image processor 30 is stored in a log record storage unit 42. FIG. 3 shows an example of the log record stored in the log record storage unit 42. In the exemplified embodiment, the individual log record has information items including a log ID, date-and-time, a machine ID, a user ID, the viewing image data, and access information for the recording image data. The log ID is identification information of the log record. In the exemplified configuration, the log ID is generated by a combination of identification information of the image processor 30 executing the process of the log record (machine ID) and unique identification information within the image processor 30. With the use of such a log ID generation method, each image processor 30 can independently generate log IDs which are unique over the entire system. This log ID generation method, however, is only exemplary. Alternatively, it is also possible to employ a configuration in which the log management device 40 assigns a log ID and notifies the log ID to an image processor 30 which executes the process corresponding to the log record. The date-and-time is, for example, the date and time when the image processor 30 executed a process corresponding to the log record, and the machine ID is identification information of the image processor 30. The user ID is identification information of a user instructing the execution of the process corresponding to the log record and is included, for example, in the instruction data transmitted from the client device 20 to the image processor 30. Alternatively, it is also possible to employ a configuration in which, when a user wishes to use the image processor 30, manual input of the user ID and authentication information is required, or a card or the like storing the user ID is read to obtain the user ID. The viewing image data and the access information for the recording image data have already been explained. In the exemplified configuration, the access information for the recording image data is the network address of the data, but the access information is not limited to such information. In addition, in the exemplified configuration, a name including the log ID is used as the file name of the recording image data, to ensure that the file name is unique, but this is only exemplary, and the present invention is not limited to such a configuration.

The information items of the log record described above are merely examples. The log record may contain only some of the exemplified items or may contain items other than the exemplified items. The image processor 30 may generate all of the items of the log record, or the log record management device 40 may generate a portion of the items. For example, the log ID and date-and-time may be generated by the log management device 40.

The log management device 40 has a UI processor 44. The UI processor 44 provides an administrator operating the administrator device 50 with a UI for search and checking of the log record. The UI processor 44 provides a UI screen for presenting information and for receiving an input from the administrator in the form of, for example, a webpage. In this case, the administrator device 50 is only required to have a web browser. The UI processor 44 provides one or more of various UI screens such as, for example, a UI screen in which log records are displayed in time sequence, a UI screen having an input field for a search condition for the log record, a UI screen in which found log records are displayed in a list, and a UI screen in which the viewing image data for the log record are displayed. The UI screen displaying the viewing image data is generated by a viewing image presentation processor 45. A recording image presentation processor 46 of the UI processor 44 acquires from the client device 20 recording image data designated by the administrator via the administrator device 50 and provides the recording image data to the administrator device 50.

As described, in the system of FIG. 2, (1) when the user instructs an image output process from the client device 20 to the image processor 30, (2a) the image processor 30 registers, to the log management device 40, a log record including viewing image data for the process, and (2b) registers, to the recording image storage unit 24 of the instructing client device 20, the recording image data having an image quality necessary for investigation purposes.

When the administrator is required to investigate the log records of the log management device 40, (I) the administrator accesses the log management device 40 through the administrator device 50 and searches for a log record or views the log record. If the required information is stored in the log record storage unit 42 of the log management device 40, the UI processor 44 can provide the information to the administrator device 50. For example, if leakage of a document is suspected, the administrator views the images represented by the viewing image data of the log data, so that the administrator can roughly narrow down the viewing images that closely resemble the leaked document. In this process, there may be cases where the log record identified on the basis of the viewing image data, for example, must be further investigated by the administrator by seeing more detailed recording image data. In the case where the administrator must further investigate the recording image data corresponding to the log record, (II) the administrator instructs the log management device 40 to present recording image data corresponding to the log record. (III) In response to this instruction, the recording image presentation processor 46 of the log management device 40 acquires the recording image data from the recording image storage unit 24 of the client device 20 storing the recording image data, using the access information for the recording image data contained in the log record. (IV) The recording image presentation processor 46 provides the administrator device 50 with a UI screen in which the recording image data are displayed in the form of, for example, a webpage.

In the example configuration of FIGS. 2 and 3, the access information for the recording image data is registered in the log management device 40 as a part of the log record. Alternatively, the access information may be stored in the image processor 30 which executed the image output process. In this case, when the log management device 40 receives a request from the administrator for the recording image data corresponding to the log record, the log management device 40 acquires access information for the recording image data from the image processor 30 and uses the access information to acquire the recording image data from the client device 20. When a machine ID of the image processor 30 which executed the process is present in the log record, the log management device 40 can use the machine ID to access the image processor 30 having the access information for the recording image data. In this case, the image processor 30 may be configured to have, for example, the access information in correspondence to the identification information such as the log ID. The log management device 40 notifies the image processor 30 of the identification information to identify the access information that the log management device 40 desires to acquire.

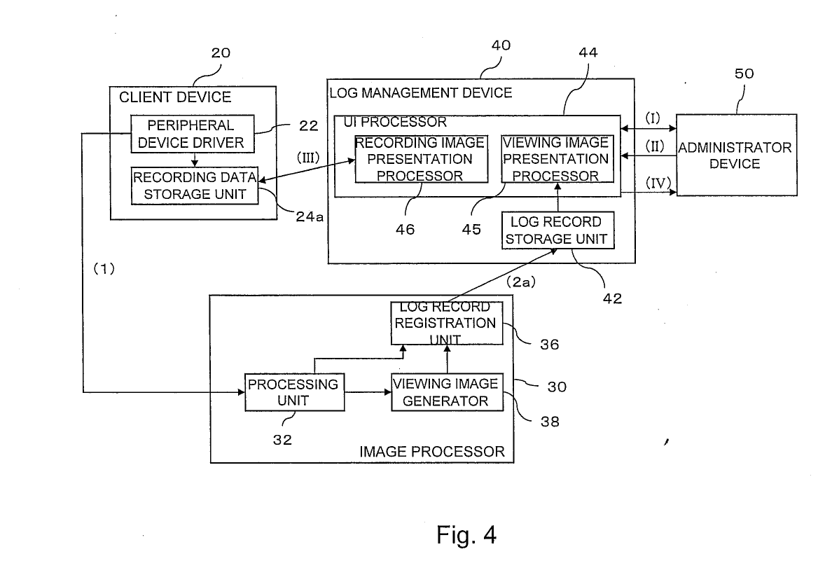

By reference to FIG. 4, another example configuration will now be described. In the example configuration of FIG. 2, the image processor 30 generates the recording image data and transmits the recording image data to the client device 20 instructing the image output, and the client device 20 stores the recording image data. In contrast, in the example configuration of FIG. 4, the client device 20 stores data representing an image to be output from the image processor 30 (hereinafter referred to as “recording data”) in a recording data storage unit 24a. For example, when the client device 20 instructs the image processor 30 to print or transmit via facsimile, because the client device 20 generates data representing the image to be output and transmits the data to the image processor 30, such data can be stored in the recording data storage unit 24a. The recording data may be, for example, data generated by the peripheral device driver 22 for the instruction (for example, PDL data, image data for print instruction, or image data for transmission instruction via facsimile) or may be a document file in an application from which the recording data originates (for example, word processor files or spreadsheet files). In this configuration, the recording image registration unit 34 in the image processor 30 is not necessary.

In the example configuration of FIG. 4, for example, the access information for the recording data stored in the recording data storage unit 24a (for example, address information on the network) may be transmitted from the client device 20 to the image processor 30 in correspondence to the instruction data for instructing the image output, and from the image processor 30 to the log management device 40.

Alternatively, it is also possible to employ a configuration in which the client device 20 transmits the access information directly to the log management device 40. Information necessary for accessing the log management device 40 such as the address of the log management device 40 or the like may be registered in the client device 20 in advance.

In this case, the log management device 40 must store in the log record storage unit 42 the access information transmitted from the client device 20 in correspondence to the log record transmitted from the image processor 30. For this purpose, for example, the client device 20 may assign a unique ID to the recording data, transmit the access information to the log management device 40 along with the ID, and pass the ID to the image processor 30 in correspondence to the instruction data, and the image processor 30 may transmit the log record in correspondence to the ID to the log management device 40. On the basis of the correspondence relationship of the ID, the log management device 40 correlates the access information to a suitable log record. Alternatively, in place of the client device 20 assigning the ID for correspondence, it is also possible to employ a configuration in which the image processor 30 assigns the ID and notifies the client device 20. For example, the image processor 30 may assign a log ID to a log record and notify the log ID to the client device 20, and the client device 20 may transmit to the log management device 40 the access information corresponding to the log ID.

When a recording image of a log record is requested by the administrator device 50, the recording image presentation processor 46 of the log management device 40 acquires, from the client device 20, recording data corresponding to the log record, generates a recording image based on the recording data, and provides the recording image to the administrator device.

In the example configurations of FIGS. 2 and 4, because the recording image data or the recording data are stored in the client device 20, the data may be deleted or changed by a user operating the client device 20.

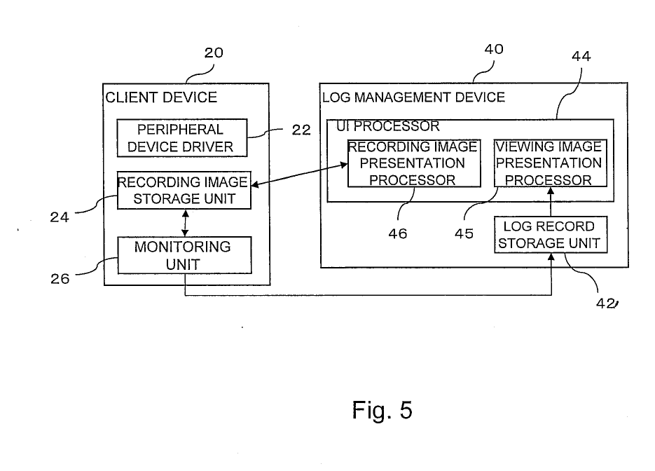

FIG. 5 shows a system which is an example system for handling such deletion or change. In FIG. 5, the image processor 30 is not shown. In the example system of FIG. 5, a monitoring unit 26 is provided in the client device 20. The monitoring unit 26 executes a predetermined handling operation when the user executes a predetermined operation involving deletion of data or change in the data with respect to recording image data or recording data (hereinafter collectively referred to as “recording image data” for convenience) stored in the recording image storage unit 24 (or the recording data storage unit 24a). An example of the handling operation is a process to record the operation in the log record storage unit 42 of the log management device 40. As a record of operation, it is possible to use, for example, the type of operation (for example, whether the operation is deletion or change), date and time, and identification information of the operating user. Such a record of operation is registered in the log record storage unit 42 in correspondence to the log record corresponding to the recording image data to be operated. For this purpose, the client device 20 may store the identification information for correlating the log record (for example, log ID as described above) in correspondence with each of the sets of recording image data. The monitoring unit 26 will transmit the operation record along with the identification information to the log management device 40.

Alternatively, as another method for handling operations such as deletion and change, it is also possible to employ a configuration in which the monitoring unit 26 transfers the recording image data before execution of the operation to the log management device 40 or a predetermined storage device on the network. The address of the storage location which is the destination of the transfer may be preset in the client device 20. When the recording image data is transferred, the monitoring unit 26 notifies the log management device 40 of information for identifying the transferred recording image data and access information for enabling access to the transferred recording image data (such as, for example, an address). In this manner, the log management device 40 can acquire the transferred recording image data.

In the above-described example configurations, the recording image data stored in the client device 20 are transferred at the time of operation with respect to the data. The transfer of the recording image data may be at a different timing. For example, the recording image data may be transferred when a number of files of the recording image data in the client device 20 reaches a predetermined number or greater or when a total amount of data of the recording image data in the client device 20 reaches a predetermined amount or greater. This configuration contributes to, for example, securing a storage capacity which can be used by the user in the client device 20.

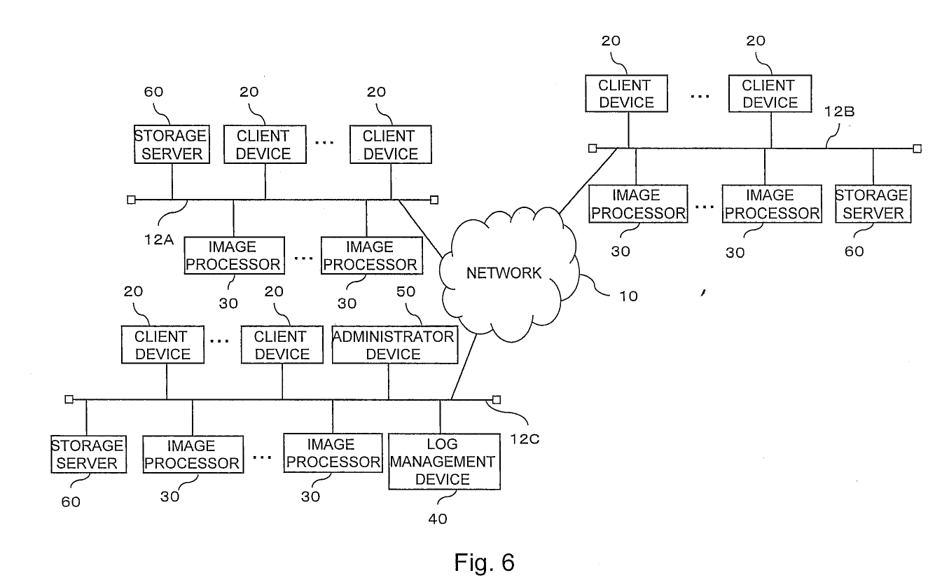

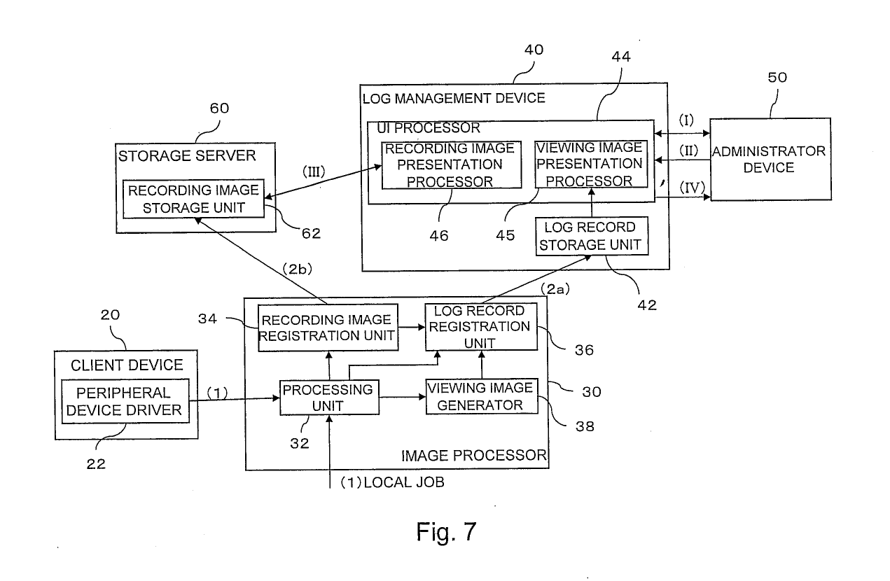

Next, another example configuration will be described with reference to FIGS. 6 and 7. In this example configuration, multiple storage servers 60 are provided on the network 10 or sub-networks 12A-12C. The storage server 60 is a server which stores recording image data. In each image processor 30, the address of the storage server 60 which stores the recording image data is set. (1) When the processing unit 32 executes a process in accordance with an instruction from a client device 20 or an instruction by a user with respect to the user interface of the image processor 30, (2b) the recording image registration unit 34 of the image processor 30 registers the recording image data in the storage server 60, and (2a) registers a log record including access information corresponding to the data to the log record storage unit 42 of the log management device 40. In the other cases in this system, processes are executed in a manner similar to that employed in connection with the configuration of FIG. 2.

In the above-described example configurations, the administrator operates the log management device 40 through the administrator device 50, but the present invention is not limited to such a configuration, and the administrator may check the logs by directly operating the log management device 40.

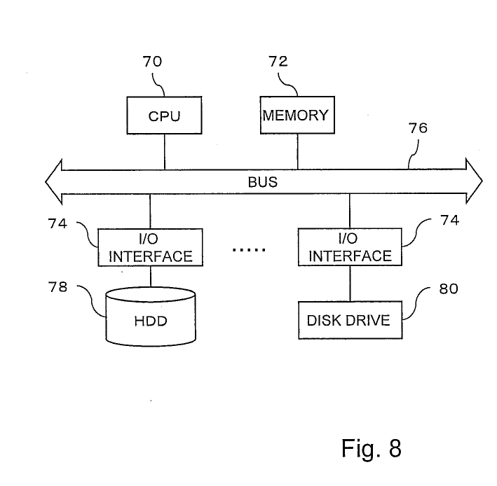

The client device 20 in the system as described above is typically realized by executing, on a general-purpose computer, a program describing functions or processes of the units in the client device 20. As shown in FIG. 8, the computer may have, as hardware, for example, a circuit structure in which a CPU (Central Processing Unit) 70, a memory (primary storage) 72, various I/O (input/output) interfaces 74, etc. are connected via a bus 76. A hard disk drive 78 or a disk drive 80 for reading transportable nonvolatile recording media of various standards such as CD, DVD, and flash memory is connected to the bus 76 via, for example, the I/O interface 74. The drive 78 or 80 functions as an external storage device for the memory. A program describing the processes of the exemplary embodiment is stored in a fixed storage device such as the hard disk drive 78 via a recording medium such as CD or DVD or via a network, and is installed in a computer. When the program stored in the fixed storage device is read into the memory and executed by the CPU, the processes of the exemplary embodiment are realized. Similarly, the log management device 40 is realized by executing a program describing the function or process of each of the units on a general-purpose computer. In the image processor 30 also, elements other than those that are constructed from a hardware circuit and are used in the printing, scanning, or facsimile function (such as, for example, the recording image registration unit 34 and the log record registration unit 36) are realized by executing a program describing the function or process of the units on a general-purpose computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An image log record management system comprising:
a plurality of image processors; and
an image log record management device, wherein
each of the image processors comprises:
a processing unit that executes an image output process;
a first registration unit that registers recording image data corresponding to an output image of the image output process in a retaining device which can be read from the image log record management device;
a viewing image generator that generates viewing image data based on the output image, the viewing image data having a reduced amount of data as compared with the recording image data; and
a second registration unit that registers, to the image log record management device, log record data including the viewing image data and access information for enabling access to the recording image data registered in the retaining device, and
the image log record management device comprises:
a storage unit that stores log record data registered from the image processor;
a first presentation processor that executes a process for presenting viewing image data included in log record data stored in the storage unit; and
a second presentation processor that executes a process for acquiring recording image data from the retaining device using access information included in selected log record data and presenting the recording image data.

2. The image log record management system according to claim 1, further comprising:
a notification unit that, upon execution of an operation which involves change or deletion with respect to recording image data registered in the retaining device, notifies the image log record management device of information related to the operation.

3. The image log record management system according to claim 2, further comprising:
a third registration unit that, upon execution of an operation which involves change or deletion with respect to recording image data registered in the retaining device, registers, in a second retaining device, the recording image data before execution of the operation, wherein
the notification unit notifies, as the information related to the operation, information including access information for enabling access to the recording image data registered in the second retaining device.

4. An image processor comprising:
a processing unit that executes an image output process;
a first registration unit that registers recording image data corresponding to an output image of the image output process in a predetermined retaining device which can be accessed from an image log record management device which manages log record data of an image output process;
a viewing image generator that generates viewing image data based on the output image, the viewing image data having a reduced amount of data as compared with the recording image data; and
a second registration unit that registers, to the image log record management device, log record data including the viewing image data and access information for enabling access to the recording image data registered in the retaining device.

5. A computer-readable medium storing a program causing a computer to execute a process, the process comprising:
registering, according to an image output process of an image processor, recording image data corresponding to an output image of the image output process in a predetermined retaining device which can be accessed from an image log record management device which manages log record data of an image output process;
generating viewing image data based on the output image, the viewing image data having a reduced amount of data as compared with the recording image data; and
registering, to the image log record management device, log record data including the viewing image data and access information for enabling access to the recording image data registered in the retaining device.

6. An image log record management system comprising:
an information processor;
an image processor; and
an image log record management device, wherein
the information processor comprises:
a transmission unit that transmits, to the image processor, instruction data indicating an output image to be output from the image processor;
a storage unit that stores recording data representing the output image; and
an access information registration unit that executes a process for registering, to the image log record management device, access information for enabling access to recording data stored in the storage unit;
the image processor comprises:
a processing unit that executes an image output process in accordance with instruction data received from the information processor;
a viewing image generator that generates viewing image data based on an output image of the image output process; and
a registration unit that registers, to the image log record management device, log record data including the viewing image data, and
the image log record management device comprises:
a storage unit that stores, in correspondence with each other, log record data registered from the image processor and access information corresponding to the log record data;
a first presentation processor that executes a process for presenting viewing image data included in the log record data stored in the storage unit; and
a second presentation processor that executes a process for acquiring recording data from the information processor using access information corresponding to selected log record data and presenting the recording data.

7. An information processor comprising:
a transmission unit that transmits, to an image processor, instruction data indicating an output image to be output from the image processor;
a storage unit that stores recording data representing the output image; and
an access information registration unit that executes a process for registering, to a predetermined image log record management device, access information for enabling access to recording data stored in the storage unit in correspondence to log record data of a process executed by the image processor in accordance with the instruction data.

8. A computer-readable medium storing a program causing a computer to execute a process, the process comprising:
transmitting, to an image processor, instruction data indicating an output image to be output from the image processor;
storing recording data representing the output image; and
registering, to a predetermined image log record management device, access information for enabling access to stored recording data in correspondence to log record data of a process executed by the image processor in accordance with the instruction data.
